(19) United States
(12) Patent Application Publication
(10) Pub. No.: US 2022/0064470 A1
(43) Pub. Date: Mar. 3, 2022

(54) LIQUID ELECTROPHOTOGRAPHIC INK COMPOSITIONS

(71) Applicant: Hewlett-Packard Development Company, L.P., Spring, TX (US)

(72) Inventors: Gregory Katz, Nes Ziona (IL); Dima LIBSTER, Nes Ziona (IL); Yaron GRINWALD, Nes Ziona (IL); Ofir BROS, Nes Ziona (IL); Albert TEISHEV, Nes Ziona (IL); Vered MAAGAN, Nes Ziona (IL)

(73) Assignee: Hewlett-Packard Development Company, L.P., Spring, TX (US)

(21) Appl. No.: 17/414,518

(22) PCT Filed: Jun. 6, 2019
(86) PCT No.: PCT/US2019/035795

§ 371 Date: Jun. 16, 2021

(51) Int. Cl. C09D 11/52; C08K 3/04; C08G 77/46; G03G 9/13; G03G 9/135

(52) U.S. Cl. CPC C09D 11/52; C08K 3/041; G03G 9/135; G03G 9/132; C08G 77/46

(57) ABSTRACT

A liquid electrostatic ink composition is described comprising carbon nanotubes; a resin; and a dispersant comprising at least one polysiloxane in an amount from about 0.01 wt. % to about 30 wt. % based on the combined weight of carbon nanotubes and resin. In some examples, the polysiloxane is a trisiloxane and has at least one polyether group. Also described is an environmental sensor comprising a printed conductive trace formed by printing an electrophotographic ink composition comprising carbon nanotubes, a resin and a dispersant. The dispersant may be an organic hydrocarbon based dispersant, such as a basic amine dispersant, or a polysiloxane dispersant.

### BACKGROUND

Electrophotographic printing processes, sometimes termed electrostatic printing processes, typically involve creating an image on a photoconductive surface, applying an ink having charged particles to the photoconductive surface, such that they selectively bind to the image, and then transferring the charged particles in the form of the image to a print substrate.

The photoconductive surface may be on a cylinder and is often termed a photo imaging plate (PIP). The photoconductive surface is selectively charged with a latent electrostatic image having image and background areas with different potentials. For example, a liquid electrophotographic (LEP) ink composition including ink particles in a liquid carrier can be charged by applying a developing voltage to the LEP ink composition to provide charged ink particles which are then brought into contact with the selectively charged photoconductive surface. The charged ink particles adhere to the image areas of the latent image while the background areas remain clean. The image is then transferred to a print substrate (e.g. paper) directly or, by being first transferred to an intermediate transfer member, which can be a soft swelling blanket, which is often heated to fuse the solid image and evaporate the liquid carrier, and then to the print substrate.

Some previous LEP ink compositions comprising cyan, magenta or black colorants have been found to suffer from electrical fatigue. Electrical fatigue may cause the charging property of a LEP ink composition to change, for example an increase in particle conductivity, when exposed to electrical fields for prolonged periods of time. If particle conductivity of the LEP ink composition changes, the number of particles transferred to the photoconductive surface in a liquid electrostatic printing process changes for a given developing voltage, resulting in a different thickness of ink being transferred to the print substrate which may cause a decline in the optical density of the printed image. Some previous solutions to this problem include correcting the developing voltage applied to the LEP ink composition in order to preserve the optical density.

### BRIEF DESCRIPTION OF THE DRAWINGS

FIG. 1 is a graph showing correlation between resistivity and printing thickness and conductivity and printing thickness.

### DETAILED DESCRIPTION

Before the compositions, methods and related aspects of the disclosure are disclosed and described, it is to be understood that this disclosure is not restricted to the particular process features and materials disclosed herein because such process features and materials may vary somewhat. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “liquid carrier”, “carrier liquid”, “carrier,” or “carrier vehicle” refers to the fluid in which the polymer resin, CNT, dispersant, colorants, charge directors and/or other additives can be dispersed to form a liquid electrostatic ink or electrophotographic ink. Liquid carriers can include a mixture of a variety of different agents, such as surfactants, co-solvents, viscosity modifiers, and/or other possible ingredients.

As used herein, “electrostatic ink composition” generally refers to an ink composition, which may be in liquid form, generally suitable for use in an electrostatic printing process, sometimes termed an electrophotographic printing process. The electrostatic ink composition may include chargeable particles of resin, carbon nanotubes, dispersant and additional agents, such as colorants, dispersed in a liquid carrier, which may be as described herein.

As used herein, “co-polymer” refers to a polymer that is polymerized from at least two monomers.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of moulding. In the present disclosure, “melt flow rate” is measured per ASTM D1238-04c Standard Test Method for Melt Flow Rates of Thermoplastics by Extrusion Plastometer. If a melt flow rate of a particular polymer is specified, unless otherwise stated, it is the melt flow rate for that polymer alone, in the absence of any of the other components of the electrostatic composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa-s or cPoise. In some examples, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic(ally) printing” or “electrophotographic(ally) printing” generally refers to the process that provides an image that is transferred from a photo imaging substrate or plate either directly or indirectly via an intermediate transfer member to a print substrate, e.g. a paper substrate. As such, the image is not substantially absorbed into the photo imaging substrate or plate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrophotographic ink composition to an electric field, e.g. an electric field having a field strength of 1000 V/cm or more, in some examples 1000 V/mm or more.

As used herein, the term “NVS” is an abbreviation of the term “non-volatile solids”.

As used herein, the term “about” is used to provide flexibility to a numerical range endpoint by providing that a given value may be a little above or a little below the endpoint. The degree of flexibility of this term can be dictated by the particular variable.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, loadings, amounts, and other numerical data may be expressed or presented herein in a range format. It is to be understood that such a range format is used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless specified otherwise, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

Described herein is an electrophotographic ink composition comprising: carbon nanotubes; a resin; and a dispersant comprising at least one polysiloxane.

The dispersant is present in an amount from about 0.01 wt. % to about 30 wt. % based on the combined weight of carbon nanotubes and resin.

In certain examples, the dispersant is present in an amount of from about 0.01 wt. % to about 20 wt. % based on the combined weight of carbon nanotubes and resin; or from about 0.01 wt. % to about 10 wt. %; or from about 0.01 wt. % to about 5 wt. %; or from about 0.01 wt. % to about 3 wt. % based on the combined weight of carbon nanotubes and resin.

The polysiloxane may be a trisiloxane.

In certain examples, the polysiloxane has at least one polyether group. Optionally, the at least one polyether group is a polymethyl ether group, a polyethyl ether group, a polypropyl ether group or a polyether block copolymer comprising polyether groups selected from methyl ether, ethyl ether and propyl ether.

The polysiloxane may be a polyalkylsiloxane. Optionally, the alkyl groups of the polyalkylsiloxane are selected from methyl, ethyl, n-propyl and iso-propyl groups.

In certain examples, the polysiloxane is a polyethylene oxide polysiloxane or a polypropylene oxide polysiloxane or a polysiloxane of formula I:

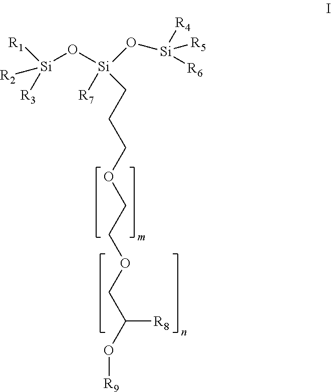

in which each of R₁ to R₉ are H, methyl or ethyl and may be the same or different; and in which m and n each equal 0 to 20 and may be the same or different provided that m+n is 2 or greater.

Optionally, the polysiloxane is a polysiloxane of formula 1 and R₁ to R₈ are each methyl and R₉ is H, methyl, ethyl or propyl.

In certain examples, n=0 and m is 2 to 12, 4 to 10 or 6 to 8.

In certain examples, the polysiloxane is a polyethylene oxide heptamethylsiloxane or polypropylene oxide heptamethylsiloxane or polypropylene oxide polyethylene oxide heptamethylsiloxane.

The polysiloxane may have a molecular weight of 300 to 900, 400 to 800, 500 to 700 or about 600.

The carbon nanotubes may be single walled carbon nanotubes or multiwalled carbon nanotubes.

The carbon nanotubes may be present in an amount of up to about 65 wt. % based on the weight of resin.

The composition may further comprise a colorant.

The composition may further comprise a carrier liquid.

At certain concentrations or loadings, the carbon nanotubes act as a colorant for the electrophotographic ink composition. In certain examples, the ink composition may comprises one or more further colorants.

Also described herein is a method of producing a liquid electrophotographic ink composition, the method comprising combining: a resin; carbon nanotubes; and a dispersant in an amount from about 0.01 wt. % to about 3 wt. % based on the combined weight of resin and carbon nanotubes, wherein the dispersant is a polysiloxane.

Also described herein is an electronic sensor for environmental gases and fumes. The sensor may be formed by printing conductive traces with the electrophotographic ink disclosed herein or by printing conductive traces using known liquid electrophotographic inks which comprise carbon nanotubes, a resin and a non-polysiloxane dispersant.

In some examples, the non-polysiloxane dispersant is an organic hydrocarbon based dispersant. In certain examples, the organic hydrocarbon based dispersant is a basic amine dispersant.

### Resin

The LEP ink composition may include a resin. For example the LEP ink composition may comprise ink particles which comprise a resin and carbon nanotubes and a polysiloxane dispersant. The ink particles may further comprise an additional colorant.

The ink particles may be chargeable particles, i.e. having or capable of developing a charge, for example in an electromagnetic field. The resin may be a thermoplastic resin. A thermoplastic polymer is sometimes referred to as a thermoplastic resin. The ink particles may be formed by combining the carbon nanotubes, any additional colorant, and dispersant, for example by grinding, for example to provide colorant particles comprising the colorant and the dispersant. The colorant particles may then be combined with a resin, for example by grinding, to provide ink particles. The resin may coat the colorant, or colorant particles comprising the colorant and basic dispersant. The particles may include a core of colorant or colorant particles and have an outer layer of resin thereon. The colorant or colorant particles may be dispersed throughout each resin-containing particle. The outer layer of resin may coat the colorant or colorant particle partially or completely.

The resin typically includes a polymer. The resin can include, but is not limited to, a thermoplastic polymer. In some examples, the polymer of the resin may be selected from ethylene acrylic acid copolymers; ethylene methacrylic acid copolymers; ethylene vinyl acetate copolymers; copolymers of ethylene (e.g. 80 wt. % to 99.9 wt. %), and alkyl (e.g. C1 to C5) ester of methacrylic or acrylic acid (e.g. 0.1 wt. % to 20 wt. %); copolymers of ethylene (e.g. 80 wt. % to 99.9 wt. %), acrylic or methacrylic acid (e.g. 0.1 wt. % to 20.0 wt. %) and alkyl (e.g. C1 to C5) ester of methacrylic or acrylic acid (e.g. 0.1 wt. % to 20 wt. %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt. % to 90 wt. %)/methacrylic acid (e.g. 0 wt. % to 20 wt. %)/ethylhexylacrylate (e.g. 10 wt. % to 50 wt. %)); ethylene-acrylate terpolymers:ethylene-acrylic esters-maleic anhydride (MAH) or glycidyl methacrylate (GMA) terpolymers; ethylene-acrylic acid ionomers and combinations thereof.

The resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer, in some examples a polymer having acidic side groups, that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt. % to about 25 wt. % of the copolymer, in some examples from 10 wt. % to about 20 wt. % of the copolymer.

The resin may comprise two different polymers having acidic side groups. The two polymers having acidic side groups may have different acidities, which may fall within the ranges mentioned above. The resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise two different polymers having acidic side groups: a first polymer that is a copolymer of ethylene (e.g. 92 to 85 wt. %, in some examples about 89 wt. %) and acrylic or methacrylic acid (e.g. 8 to 15 wt %, in some examples about 11 wt. %) having a melt flow rate of 80 to 110 g/10 minutes and a second polymer that is a co-polymer of ethylene (e.g. about 80 to 92 wt. %, in some examples about 85 wt. %) and acrylic acid (e.g. about 18 to 12 wt. %, in some examples about 15 wt %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN ionomers. The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt. % to about 16 wt. % of the copolymer, in some examples 10 wt. % to 16 wt. % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt. % to about 30 wt. % of the copolymer, in some examples from 14 wt. % to about 20 wt. % of the copolymer, in some examples from 16 wt. % to about 20 wt. % of the copolymer in some examples from 17 wt. % to 19 wt. % of the copolymer.

In an example, the resin constitutes about 5 to 90%, in some examples about 5 to 80%, by weight of the solids of the electrostatic ink composition. In another example, the resin constitutes about 10 to 60% by weight of the solids of the electrostatic ink composition. In another example, the resin constitutes about 15 to 40% by weight of the solids of the electrostatic ink composition. In another example, the resin constitutes about 60 to 95% by weight, in some examples from 80 to 90% by weight, of the solids of the electrostatic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the co-polymer, in some examples 5 to 40% by weight, in some examples 5 to 20% by weight of the copolymer, in some examples 5 to 15% by weight of the copolymer. The second monomer may constitute 1 to 50% by weight of the co-polymer, in some examples 5 to 40% by weight of the co-polymer, in some examples 5 to 20% by weight of the co-polymer, in some examples 5 to 15% by weight of the copolymer. In an example, the first monomer constitutes 5 to 40% by weight of the co-polymer, the second monomer constitutes 5 to 40% by weight of the co-polymer, and with the third monomer constituting the remaining weight of the copolymer. In an example, the first monomer constitutes 5 to 15% by weight of the co-polymer, the second monomer constitutes 5 to 15% by weight of the co-polymer, with the third monomer constituting the remaining weight of the copolymer. In an example, the first monomer constitutes 8 to 12% by weight of the co-polymer, the second monomer constitutes 8 to 12% by weight of the co-polymer, with the third monomer constituting the remaining weight of the copolymer. In an example, the first monomer constitutes about 10% by weight of the co-polymer, the second monomer constitutes about 10% by weight of the co-polymer, and with the third monomer constituting the remaining weight of the copolymer. The polymer having ester side groups may be selected from the Bynel class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In some examples, the resin is selected from PVC (polyvinyl chloride), Cumen-PSMA (cumene terminated polystyrene-co-maleic anhydride), PSE (poly (styrene-co-maleic acid) partial isobutyl/methyl mixed ester) and PVP (polyvinylpyrrolidone) resins.

In an example, the polymer or polymers of the resin can be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX76™, Nucrel 2806™, Bynell 2002, Bynell 2014, and Bynell 2020 (sold by E. I. du PONT)), the Aclyn family of toners (e.g. Aclyn 201, Aclyn 246, Aclyn 285, and Aclyn 295), and the Lotader family of toners (e.g. Lotader 2210, Lotader, 3430, and Lotader 8200 (sold by Arkema)).

In some examples, the colorant constitutes a certain wt. %, e.g. from 1 wt. %, to 30 wt. % of the solids of the electrostatic ink composition, and the remaining wt. % of the solids of the electrostatic ink composition is formed by the resin and, in some examples, any other additives that are present. The other additives may constitute 10 wt. % or less of the solids of the electrostatic ink composition, in some examples 5 wt. % or less of the solids of the electrostatic ink composition, in some examples 3 wt. % or less of the solids of the electrostatic ink composition. In some examples, the resin may constitute 5% to 99% by weight of the solids in the electrostatic ink composition, in some examples 50% to 90% by weight of the solids of the electrostatic ink composition, in some examples 70 to 90% by weight of the solids of the electrostatic ink composition. The remaining wt % of the solids in the ink composition may be a colorant and, in some examples, any other additives that may be present.

### Carbon Nanotubes

Carbon nanotubes have been described in various publications and can have a conventional meaning herein. Various types of carbon nanotubes are described, for example, in U.S. Pat. No. 6,333,016, which is incorporated herein by reference in its entirety and to which further reference should be made. J. Chem. Phys., Vol. 104, No. 5, 1 Feb. 1996 also describes carbon nanotubes of various types, for example straight walled and bent nanotubes, and this document is incorporated herein by reference in its entirety. The carbon nanotubes may be selected from straight and bent multi-walled nanotubes (MWNTs), straight and bent double-walled nanotubes (DWNTs), and straight and bent single-walled nanotubes (SWNTs), and various compositions of these nanotube forms and common by-products contained in nanotube preparations, such as described in U.S. Pat. No. 6,333,016 and WO 01/92381, also incorporated herein by reference in its entirety and to which further reference should be made.

The carbon nanotubes, e.g. single walled carbon nanotubes, may have an outer diameter of 4 nm or less, in some examples 3.5 nm or less, in some examples 3.25 nm or less, in some examples 3.0 nm or less. The carbon nanotubes may have an outer diameter of about 0.5 to about 2.5 nm, in some examples an outer diameter of about 0.5 to about 2.0 nm, in some examples an outer diameter of about 0.5 to about 1.5 nm. The carbon nanotubes may have an outer diameter of about 0.5 to about 1.0 nm.

In some examples, e.g. in multiwalled nanotubes, the carbon nanotubes have an outer diameter of 2 nm or more, in some examples 3 nm or more, in some examples 5 nm or more, in some examples 10 nm or more, in some examples 15 nm or more. In some examples, e.g. in multiwalled nanotubes, the carbon nanotubes have an outer diameter of 2 nm to 50 nm.

In some examples, the carbon nanotubes comprise single walled carbon-based SWNT-containing material. SWNTs can be formed by a number of techniques, such as laser ablation of a carbon target, decomposing a hydrocarbon, and setting up an arc between two graphite electrodes.

The present inventors have found that species with low symmetry, such as elongate species such as carbon nanotubes, are effective when used in electrostatic printing of conductive traces. In an electrostatic ink composition that comprises resin-containing particles in which the elongate species are encapsulated (partially or completely), the distribution of elongate species is typically randomised. This may be due to the production of the resin particles containing the elongate species. In an electrostatic printing process, in which the resin particles can be subjected to high potential gradients, the randomised distribution has been found to lower the propensity of the elongate species to form conductive paths through the particles. This minimises electrical discharge through the resin particles. However, the present inventors have found that when resin particles are fused, which may be by the application of heat, this can result in alignment and interconnection of the elongate species, thus increasing their ability to conduct through the resin, e.g. when printed on a substrate.

The present inventors have determined that commercially available carbon nanotubes are suitable for use in examples of the present disclosure, including NC7000 (available from NanoCyl), short multi-wall CNT from Cheaptubes and single-wall CNT from OXCIAL.

In some examples, the electrostatic ink composition is used for printing conductive traces on a substrate using Liquid Electro-Photography. In some examples, the conductive trace is printed using Liquid Electro-Photography. In some example, said printing will comprise electrostatic printing.

An elongate species may be a species having a first dimension that is longer that each of a second dimension and a third dimension, wherein the first, second and third dimensions are perpendicular to one another. In some examples, the elongate conductive species is rod-shaped. In some examples, the elongate conductive species may have an aspect ratio between 2 and 2000. As described herein, aspect ratio may be defined as the ratio of the length of the longest dimension of an elongate conductive species (e.g. the first dimension described above) to the length of the next-to-longest dimension (e.g. the second or third dimension described above), wherein the dimensions are perpendicular to one another. The elongate conductive species may have an aspect ratio at least 2, in some examples at least 3, in some examples at least 4, in some examples at least 5, in some examples at least 6, in some examples at least 7, in some examples at least 8, in some examples at least 9, in some examples at least 10, in some examples at least 11, in some examples at least 12, in some examples at least 13, in some examples at least 14, in some examples at least 15, in some examples at least 16, in some examples at least 17, in some examples at least 18, in some examples at least 19, in some examples at least 20.

The elongate conductive species may have an aspect ratio of at least 25, in some examples at least 25, in some examples at least 30, in some examples at least 40, in some examples at least 50, in some examples at least 60, in some examples at least 70, in some examples at least 80, in some examples at least 90, in some examples at least 100, in some examples at least 150, in some examples at least 200, in some examples at least 300, in some examples at least 400, in some examples at least 500, in some examples at least 1000 in some examples at least 1500, in some examples at least 2000.

In some examples, the elongate conductive species may have an aspect ratio less than 50, for example less than 45, for example less than 40, for example less than 35, for example less than 30, for example less than 25, for example less than 20, for example less than 10, for example less than 9, for example less than 8, for example less than 7, for example less than 6, for example less than 5, for example less than 4, for example less than 3, for example less than 2.

The carbon nanotubes may be present in the electrostatic ink composition and/or conductive trace in an amount of from about 0.001 wt. % to about 30 wt. % of the solids content (of the electrostatic ink composition), 1 wt. % to about 25 wt. % of the solids content, in some examples in an amount of from about 5 wt. % to about 25 wt. % of the solids content, in some examples in an amount of from about 5 wt. % to about 20 wt. % of the solids content, in some examples about 5 wt. % to about 15 wt. % of the solids content.

The carbon nanotubes may be present in the electrostatic ink composition and/or conductive trace in an amount of at least about 0.001 wt. % of the solids content (of the electrostatic ink composition), for example in an amount of at least about 0.01 wt. % of the solids content, for example in an amount of at least about 0.1 wt. % of the solids content, for example in an amount of at least about 0.5 wt. % of the solids content, for example in an amount of at least about 1 wt. % of the solids content, for example in an amount of at least about 2 wt. % of the solids content, for example in an amount of at least about 3 wt. % of the solids content, for example in an amount of at least about 5 wt. % of the solids content, for example in an amount of at least about 7 wt. % of the solids content, for example in an amount of at least about 10 wt. % of the solids content, for example in an amount of at least about 15 wt. % of the solids content.

The carbon nanotubes may be present in the electrostatic ink composition and/or conductive trace in an amount of 65 wt. % or less of the solids content (of the electrostatic ink composition), in some examples in an amount 25 wt. % or less of the solids content, in some examples in an amount 20 wt. % or less of the solids content, in some examples in an amount 15 wt. % or less of the solids content, in some examples in an amount 10 wt. % or less of the solids content, in some examples in an amount 5 wt. % or less of the solids content.

### Dispersant

The LEP ink composition comprises a polysiloxane dispersant. The dispersant prevents agglomeration of carbon nanotubes, improves the CNT dispersion into the ink and allows the ink to maintain the required electrical resistance at lower nanotube and pigment loadings. It has been determined that the dispersants of the present disclosure show improved nanotube dispersion and, as a result, provide inks with lower electrical resistance with less CNT together with improved image transfer from the transfer roller/blanket onto the print substrate.

In certain examples, the polysiloxane is a trisiloxane, in particular a polysiloxane having at least one polyether group. The polyether group may be selected from polymethyl ether group, polyethyl ether group, polypropyl ether group or may be a polyether block copolymer comprising polyether groups selected from methyl ether, ethyl ether and propyl ether.

The dispersant is present in an amount from about 0.01 wt. % to about 30 wt. % based on the combined weight of carbon nanotubes and resin. In certain examples, the dispersant is present in an amount of from about 0.01 wt. % to about 20 wt. % based on the combined weight of carbon nanotubes and resin; or from about 0.01 wt. % to about 10 wt. %; or from about 0.01 wt. % to about 5 wt. %; or from about 0.01 wt. % to about 3 wt. % based on the combined weight of carbon nanotubes and resin.

In certain examples, the polysiloxane is a polyalkylsiloxane. The alkyl groups of the polyalkylsiloxane may be selected from methyl, ethyl, n-propyl and iso-propyl groups.

In some examples, the polysiloxane is a polyethylene oxide polysiloxane or a polypropylene oxide polysiloxane or a polysiloxane of formula I:

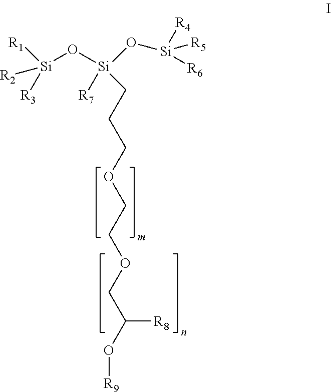

in which each of R₁ to R₉ are H, methyl or ethyl and may be the same or different; and in which m and n each equal 0 to 20 and may be the same or different provided that m+n is 2 or greater.

In certain examples, the polysiloxane is a polysiloxane of formula 1 and wherein R₁ to R₈ are each methyl and R₉ is H or methyl.

In certain examples, n=0 and m is 2 to 12 or 4 to 10 or 6 to 8 or 7.

In certain examples, the polysiloxane is a polyethylene oxide heptamethylsiloxane or polypropylene oxide heptamethylsiloxane or polypropylene oxide polyethylene oxide heptamethylsiloxane.

In certain examples, the polysiloxane has a molecular weight of 300 to 900, 400 to 800, 500 to 700 or about 600.

In certain examples, the polysiloxane is a trisiloxane Silwet polymer, such as Silwet L-77 or Silwet L-7280, obtainable from Momentive Performance Materials Inc.

In certain examples, the polysiloxane has a hydrophilic-lipophilic-balance (HLB) value of about 5 or higher or about 10 or higher. In some examples, the polysiloxane has an HLB value of about

The LEP ink composition may comprise 0.01 to 12 wt. % of polysiloxane dispersant based on the combined weight of resin and carbon nanotubes. In some examples, the dispersant may constitute from 0.1 wt. % to 3 wt, in some examples from about 0.5 to about 1.5 wt. %.

### Carrier Liquid

The electrostatic ink composition may include a liquid carrier. In some examples, the electrostatic ink composition comprises ink particles including the resin may be dispersed in the liquid carrier. The liquid carrier can include or be a hydrocarbon, silicone oil, vegetable oil, etc. The liquid carrier can include, for example, an insulating, non-polar, non-aqueous liquid that can be used as a medium for ink particles, i.e. the ink particles including the resin, carbon nanotubes, dispersant and any other components, such as colorants. The liquid carrier can include compounds that have a resistivity in excess of about 10⁹ ohm·cm. The liquid carrier may have a dielectric constant below about 5, in some examples below about 3. The liquid carrier can include hydrocarbons. The hydrocarbon can include, for example, an aliphatic hydrocarbon, an isomerized aliphatic hydrocarbon, branched chain aliphatic hydrocarbons, aromatic hydrocarbons, and combinations thereof. Examples of the liquid carriers include, for example, aliphatic hydrocarbons, isoparaffinic compounds, paraffinic compounds, dearomatized hydrocarbon compounds, and the like. In particular, the liquid carriers can include, for example, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

In certain examples, the carrier liquid dilutes the ink composition to provide a CNT loading of about 0.01 wt. % to about 50 wt. %. In some examples, the CNT loading is about 5 to about 30 wt. %.

### Colorant

At certain loadings in the ink, the carbon nanotubes may act as a colorant for the ink. In some examples, the LEP ink may include a colorant or further colorant. The colorant may be a dye or pigment or a combination thereof. The colorant can be any colorant compatible with the liquid carrier and useful for electrophotographic printing. For example, the colorant may be present as pigment particles, or may comprise a resin (in addition to the polymers described herein) and a pigment.

The colorant may be transparent, unicolor or composed of any combination of available colours. The colorant may be selected from a cyan colorant, a yellow colorant, a magenta colorant and a black colorant. The electrostatic ink composition and/or conductive trace may comprise a plurality of colorants. The electrostatic ink composition and/or conductive trace may comprise a first colorant and second colorant, which are different from one another. Further colorants may also be present with the first and second colorants. The electrostatic ink composition and/or conductive trace may comprise first and second colorants where each is independently selected from a cyan colorant, a yellow colorant, a magenta colorant and a black colorant. In some examples, the first colorant comprises a black colorant, and the second colorant comprises a non-black colorant, for example a colorant selected from a cyan colorant, a yellow colorant and a magenta colorant. The colorant may be selected from a phthalocyanine colorant, an indigold colorant, an indanthrone colorant, a monoazo colorant, a diazo colorant, inorganic salts and complexes, dioxazine colorant, perylene colorant, anthraquinone colorants, and any combination thereof.

The colorant, dye or pigment may be present in the LEP ink composition in an amount of from about 0.1 wt. % to about 80 wt. % by total weight solids of the LEP ink. In some examples, the colorant may be present in the ink composition in an amount of from about 10 wt. % to about 60 wt. %, in some examples about 10 wt. % to about 50 wt. %, in some examples about 10 wt. % to about 40 wt. %, in some examples about 10 wt. % to about 30 wt. %, in some examples about 15 wt. % to about 30 wt. % weight solids of the LEP ink. In some examples, the colorant particle may be present in the LEP ink in an amount of at least about 10 wt. % weight solids of the LEP ink, for example at least about 15 wt. % weight solids of the LEP ink.

In some examples, the LEP ink composition comprises ink particles, for example ink particles comprising a resin and a colorant. In some examples, the ink particles comprise a resin, a colorant and a dispersant. The ink particles may be provided with a pigment loading of about 5-40% w/w, in some examples about 10-30% w/w. The term “pigment loading” may be used to refer to the amount of colourant by total weight of solids of the LEP ink composition. In some examples, the term “pigment loading” refers to the average content of the colourant in the ink particles. In some examples, the pigment loading refers to the average wt. % of the colorant in the ink particles.

### Charge Director

In some examples, the electrostatic ink composition includes a charge director. The charge director may be added to an electrostatic ink composition in order to impart and/or maintain sufficient electrostatic charge on the ink particles. In some examples, the charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of an electrostatic ink composition.

The charge director may be added in order to impart and/or maintain sufficient electrostatic charge on the ink particles, which may be particles comprising the thermoplastic resin.

In some examples, the electrostatic ink composition comprises a charge director comprising a simple salt. The ions constructing the simple salts are all hydrophilic. The simple salt may include a cation selected from the group consisting of Mg, Ca, Ba, NH₄, tert-butyl ammonium, Li⁺, and Al⁺³, or from any sub-group thereof. The simple salt may include an anion selected from the group consisting of SO₄²⁻, PO³⁻, NO³⁻, HPO₄²⁻, CO₃²⁻, acetate, trifluoroacetate (TFA), Cl⁻, BF₄⁻, F⁻, ClO₄⁻, and TiO₃⁴⁻ or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂TiO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiClO₄ and LiBF₄, or any sub-group thereof.

In some examples, the electrostatic ink composition comprises a charge director comprising a sulfosuccinate salt of the general formula MAₙ, wherein M is a metal, n is the valence of M, and A is an ion of the general formula (I): [R¹—O—C(O)CH₂CH(SO₃⁻)C(O)—O—R²], wherein each of R¹ and R² is an alkyl group. In some examples each of R₁ and R₂ is an aliphatic alkyl group. In some examples, each of R₁ and R₂ independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R₁ and R₂ are the same. In some examples, at least one of R₁ and R₂ is C₁₃H₂₇. In some examples, M is Na, K, Cs, Ca, or Ba.

In some examples, the charge director comprises at least one micelle forming salt and nanoparticles of a simple salt as described above. The simple salts are salts that do not form micelles by themselves, although they may form a core for micelles with a micelle forming salt. The sulfosuccinate salt of the general formula MAₙ is an example of a micelle forming salt. The charge director may be substantially free of an acid of the general formula HA, where A is as described above. The charge director may include micelles of said sulfosuccinate salt enclosing at least some of the nanoparticles of the simple salt. The charge director may include at least some nanoparticles of the simple salt having a size of 200 nm or less, and/or in some examples 2 nm or more.

The charge director may include one of, some of or all of (i) soya lecithin, (ii) a barium sulfonate salt, such as basic barium petronate (BPP), and (iii) an isopropyl amine sulfonate salt. Basic barium petronate is a barium sulfonate salt of a 21-26 hydrocarbon alkyl, and can be obtained, for example, from Chemtura. An example isopropyl amine sulphonate salt is dodecyl benzene sulfonic acid isopropyl amine, which is available from Croda.

In some examples, the charge director constitutes about 0.001% to 20%, in some examples 0.01% to 20% by weight, in some examples 0.01 to 10% by weight, in some examples 0.01% to 1% by weight of the solids of an electrostatic ink composition. In some examples, the charge director constitutes about 0.001% to 0.15% by weight of the solids of the electrostatic ink composition, in some examples 0.001% to 0.15%, in some examples 0.001% to 0.02% by weight of the solids of an electrostatic ink composition, in some examples 0.1% to 2% by weight of the solids of the electrostatic ink composition, in some examples 0.2% to 1.5% by weight of the solids of the electrostatic ink composition in some examples 0.1% to 1% by weight of the solids of the electrostatic ink composition, in some examples 0.2% to 0.8% by weight of the solids of the electrostatic ink composition.

In some examples, the charge director is present in an amount of from 3 mg/g to 20 mg/g, in some examples from 3 mg/g to 15 mg/g, in some examples from 10 mg/g to 15 mg/g, in some examples from 5 mg/g to 10 mg/g (where mg/g indicates mg per gram of solids of the electrostatic ink composition).

### Other Additives

The electrostatic ink composition may include another additive or a plurality of other additives. The other additive or plurality of other additives may be added at any stage of the method. The other additive or plurality of other additives may be selected from a charge adjuvant, a wax, a surfactant, viscosity modifiers, and compatibility additives. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g. from an intermediate transfer member, which may be a heated blanket. In some examples, the LEP ink composition comprises silica, which may be added, for example, to improve the durability of images produced using the LEP ink.

In some examples, the electrostatic ink composition includes a charge adjuvant. A charge adjuvant may promote charging of the particles when a charge director is present. The method as described herein may involve adding a charge adjuvant at any stage. The charge adjuvant can include, for example, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), or hydroxy bis(3,5-di-tert-butyl salicylic) aluminate monohydrate. In an example, the charge adjuvant is or includes aluminum di- or tristearate. In some examples, the charge adjuvant is VCA (aluminium stearate and aluminium palmitate, available from Sigma Aldrich).

The charge adjuvant may be present in an amount of about 0.1 to 5% by weight, in some examples about 0.1 to 1% by weight, in some examples about 0.3 to 0.8% by weight of the solids of the electrostatic ink composition, in some examples about 1 wt % to 3 wt. % of the solids of the electrostatic ink composition, in some examples about 1.5 wt % to 2.5 wt. % of the solids of the electrostatic ink composition.

The charge adjuvant may be present in an amount of less than 5.0% by weight of total solids of the electrostatic ink composition, in some examples in an amount of less than 4.5% by weight, in some examples in an amount of less than 4.0% by weight, in some examples in an amount of less than 3.5% by weight, in some examples in an amount of less than 3.0% by weight, in some examples in an amount of less than 2.5% by weight, in some examples about 2.0% or less by weight of the solids of the electrostatic ink composition.

In some examples, the electrostatic ink composition further includes, e.g. as a charge adjuvant, a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al3+. The fatty acid anion may be selected from a saturated or unsaturated fatty acid anion. The fatty acid anion may be selected from a C₈ to C₂₆ fatty acid anion, in some examples a C₁₄ to C₂₂ fatty acid anion, in some examples a C₁₆ to C₂₀ fatty acid anion, in some examples a C₁₇, C₁₈ or C₁₉ fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of a multivalent cation and a fatty acid anion, may be present in an amount of 0.1 wt. % to 5 wt. % of the solids of the electrostatic ink composition, in some examples in an amount of 0.1 wt. % to 2 wt. % of the solids of the electrostatic ink composition, in some examples in an amount of 0.1 wt. % to 2 wt. % of the solids of the electrostatic ink composition, in some examples in an amount of 0.3 wt. % to 1.5 wt. % of the solids of the electrostatic ink composition, in some examples about 0.5 wt. % to 1.2 wt. % of the solids of the electrostatic ink composition, in some examples about 0.8 wt. % to 1 wt. % of the solids of the electrostatic ink composition, in some examples about 1 wt % to 3 wt. % of the solids of the electrostatic ink composition, in some examples about 1.5 wt % to 2.5 wt. % of the solids of the electrostatic ink composition.

### EXAMPLES

The following illustrates examples of the compositions and related aspects described herein. The examples should not be considered as restricting the present disclosure, but are merely in place to teach how to make examples of compositions of the present disclosure.

### Method of Producing a LEP Ink Composition

### Example 1

An ink composition was prepared by mixing together a mixture of AC-5120 resin (Honeywell) and VCA charge adjuvant (an aluminium di- and tri-stearate and palmitate salt) in a ratio of 40:1, with commercial carbon nanotubes (NC7000 from NanoCyl, thin, multiwall CNT) and Silwet L-77 as dispersant in the following proportions:

| | | |
|---|---|---|
| AC-5120/VCA | 74 | wt. % |
| NC 7000 CNT | 25 | wt. % |
| Silwet L-77 | 1 | wt. % |

in an attritor mill running at a moderate speed with Isopar as carrier liquid at a % NVS (as described above) of 18% for four hours under 36° C. (cold milling).

NC7000 carbon nanotubes (NanoCyl) are short in length (0.5-2.0 micrometres in length) having a 3-5 nm inside diameter and a 8-15 nm outside diameter. The CNT show very low packing (very low tap density and low crystallinity) but have very high dispersibility in Isopar-L, for example. High dispersibility is apparent in a high viscosity slurry containing 10-15 wt. % CNT in Isopar-L.

### Reference Example 1

A comparative ink composition was prepared with a resin consisting of AC-5120 (Honeywell), NC7000 CNY and Nucrel 699 (DuPont/Dow) in a ratio of 8:20, VCA charge adjuvant with carbon nanotubes and Lubrizol 6406 (an amine basic dispersant) in the following proportions:

| | | |
|---|---|---|
| AC-5120/Nucrel 699 | 58 | wt. % |
| VCA | 2 | wt. % |
| NC7000 CNT | 30 | wt. % |
| Lubrizol 6406 | 10 | wt. % |

with mixing in an attritor mill for five hours at 15% NVS with Isopar as carrier liquid.

### Comparison of Ink Performance

The compositions produced according to Reference Example 1 and Example 1 were printed onto print substrates (Euroart 135 gsm) using a LEP printing apparatus (HP Indigo 7000 press). The composition of each of Reference Example 1 and Example 1 were used to print 20000 impressions (20 kimp) at 2% coverage, the optical density (OD) of each of the prints was determined for the first print (i.e. 0 kimp), the 10000th (10 kimp) print and/or the 20000th (20 kimp) print, along with the particle conductivity (PC) and developer voltage (DRV) at 0 kimp, 10 kimp and/or 20 kimp. Every 5000 impressions (5 kimp) a background check print of 0% coverage was printed for 16 separations and the optical density determined for each of these prints using an X-rite optical densitometer in order to determine the background effect of each of the inks.

The OD, optical density, was measured using an optical densitometer from X-rite company (X-rite Exact). The conductivity parameter PC, particle conductivity, is calculated by the subtraction of LF, low field conductivity form HF, high field conductivity, where LF is measured using a LF probe and the HF is measured by Q/M device that measures electrophoretic conductivity at high field. DRV (developer roller voltage) indicates the absolute voltage of the developer roller of the binary ink developer units of the printing press. The printing press used recalibrates the DRV every 6000 impressions. Electrical fatigue is observed if the particle conductivity of the ink increases when exposed to continuously to a high electric field.

Low field conductivity for Reference Example 1 was not stable, and showed substantial jumping, whereas that for Example 1 was stable, at 90 pico-Siemens (1/Ohms×10⁻¹²). Example 1 gave a particle conductivity value of 130 pico-Siemens whereas Reference Example 1 gave a value of 310 pico-Siemens. Accordingly, the composition of Example 1 had a significantly lower effect on the normal voltages of the electrophotographic press. Example 1 showed an offline plating resistance of 820 Ohms, compared with 7000 Ohms for Reference Example 1.

In the printing test, Reference Example 1 ink required an additional blanket layer for transfer of the ink to the substrate, whereas there was no need for such an additional layer for the ink of Example 1. Additionally, the ink of Example 1 showed excellent ink transfer to the substrate whereas that of Reference Example 1 showed significant background image transfer.

While the electrostatic ink compositions, methods and related aspects have been described with reference to certain examples, it will be appreciated that various modifications, changes, omissions, and substitutions can be made without departing from the spirit of the disclosure. It is intended, therefore, that the electrostatic ink compositions, methods and related aspects be limited only by the scope of the following claims. Unless otherwise stated, the features of any dependent claim can be combined with the features of any of the other dependent claims, and any other independent claim.

### Environmental Sensor

The present disclosure also includes an environmental sensor for sensing environmental gases and fumes. Such a sensor is commonly referred to as an ‘electronic nose’. The sensor is prepared by printing a liquid electrophotographic printing ink containing carbon nanotubes dispersed within a resin. The ink may be an ink as described herein comprising carbon nanotubes, a resin and a polysiloxane dispersant. In alternative examples, the ink may be an ink comprising carbon nanotubes, a resin and a non-polysiloxane dispersant. The non-polysiloxane dispersant may, for example, be a basic amine dispersant as described in our earlier application, WO 2018/019379.

The conductive trace may be printing using any suitable technique, such as that described above. A suitable technique is also described in U.S. Pat. No. 5,479,032, the disclosure of which is incorporated herein by reference and to which further reference should be made, and which describes a multicolour imaging system which may serve as a direct deposition or indirect printing system for printing electronics onto a flexible substrate. The printed toner is liquid and is electro-active in its dry state.

A colour-imaging system defined by layer-by-layer deposition using an intermediate roller is described in U.S. Pat. No. 4,690,539. Developing electrostatic latent images formed on a photoconductor surface is described in U.S. Pat. No. 4,504,138. Further details described in U.S. Pat. Nos. 3,900,003, 4,400,079, 4,342,823, 4,073,266 and 3,405,683. Further reference should be made to these publications, the disclosure of which are incorporated herein by reference in their entirety.

The conductivity of the printed trace my be modulated by printing a number of multiple layers or films, giving increased conductivity. When exposed to a range of different gas environments, the resistance of the conductive trace changes, based on the nature of the gas, concentration and exposure time.

The percolation threshold for carbon black is well studied. The symmetry of carbon black particles is close to spherical geometry. With spherical geometry, the percolation threshold of carbon black in an insulating media such resin, is at 16.7% PL (volumetric). This means that below this PL threshold the solid film is insulating and above it is conductive. Continuing with this assumption; one may calculate the PL of the carbon black in a packed liquid ink layer. It is well known that the solids concentration in the liquid packed toner (developed layer) is above 25%. This means that 65% PL of carbon black in solids will be above 16% in the packed ink layer (including insulating Isopar as carrier liquid) in the media of the packed layer. This, being close to but above, the percolation threshold, results in the packed layer being conductive.

Carbon nanotubes have lower percolation threshold level due to the lower symmetry (high 3D aspect ratio) as fillers. In a solid film, the nanotubes rods are aligned to give conductive lines with low concentration, compared to higher symmetrical fillers pigment such as carbon black pigment. However, before film-forming of the ink on the hot surface of the transfer blanket of a printing system, the random distribution of the rod structures of the carbon nanotubes is an advantage for low percolation. With the particles dispersed in the carrier liquid, creating conductive line is much lower giving wider operating voltage window in the development unit on the liquid electrophotography printing press.

The percolation may be changed in response to different gases in the environment of the printed substrate as gases may pool or well in the printed conductive composite. This results in lowering the percolation, thereby minimizing the contact between the conductive particles in the printed matrix giving rise to an increased electrical resistance of the matrix, thereby signalling exposure of the printed conductive trace to environmental gas. By this mechanism, the printed matrix is able to act as a sensor.

The resistance of a printed CNT trace may also change if environmental gases are adsorbed onto the CNT particles, thereby reducing conductivity and acting as a sensor in a similar manner.

Accordingly, in this disclosure, we describe an electronic sensor for environmental gases and fumes, hence an “electronic nose”. We disclose an electronic ink formulation containing CNT as pigment that enables printing of conductive traces on any substrate using LEP press machine. The ink formulations have good pigment dispersion in solid high adhesive wax resins using grinding process. Together with multiple printed layers, followed with or without heat cure after printing, enable a pre-definable conductivity of printed solid films. The printed elements may be used as electronic sensors when exposed to different environmental gases, showing a change in their resistance upon exposure. Sensitivity to different gases or other environmental conditions can be adjusted according to techniques known in the art of electronic noses.

### Example 2

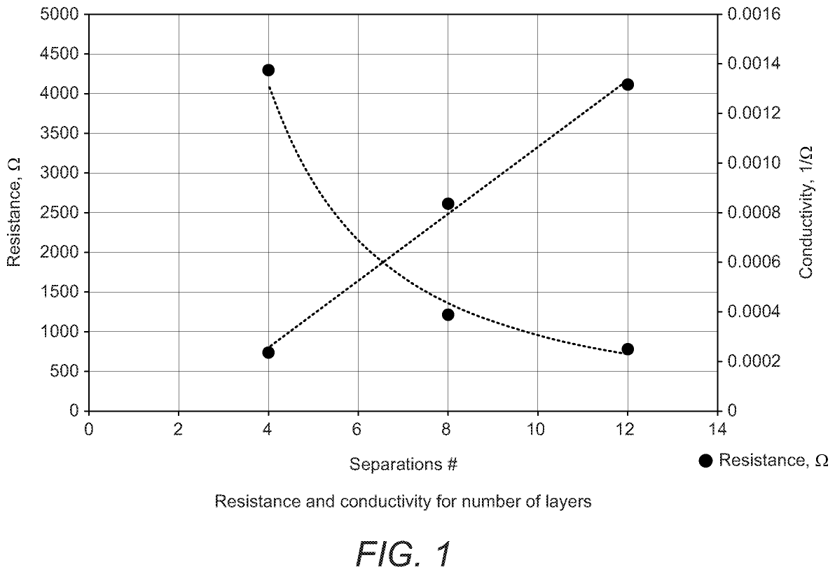

The ink composition of Example 1 was modified to give a CNT pigment loading of 40 wt. % and the ink used in electrophotographic printing to produce sensors having a range of ink thicknesses. FIG. 1 is a graph showing the correlation between thickness, defined in terms of the numbers of ink layers applied, and resistance and conductivity.

Sample printed sensors at a range of initial resistance were exposed to acetic acid and to ammonia, with the conductivity of the samples compared before exposure, after three hours' exposure and after exposure overnight (approx. 14-16 hours). The results are shown below in Tables 1 to 4.

### Acetic Acid

TABLE 1
Exposure to Acetic acid-resistance measurements at 3 hours

| | Resistance/kOhm | | |
|---|---|---|---|
| Acetic acid | Before | After 3 hours | Difference |
| Example 2a | 503 | 570 | 13% |
| Example 2b | 791 | 917 | 16% |
| Example 2c | 257 | 301 | 17% |
| Example 2d | 857 | 1015 | 18% |

TABLE 2
Exposure to Acetic acid-resistance measurements after leaving overnight

| | Resistance/kOhm | | |
|---|---|---|---|
| Acetic acid | Before | After overnight | Difference |
| Example 2e | 282 | 364 | 29% |
| Example 2f | 287 | 364 | 27% |
| Example 2g | 380 | 457 | 20% |
| Example 2h | 374 | 438 | 17% |

### Ammonia

TABLE 3
Exposure to Ammonia-resistance measurements at 1.5 hours

| | Resistance/kOhm | | |
|---|---|---|---|
| Ammonia | Before | After 1.5 hours | Difference |
| Example 2i | 805 | 1200 | 49% |
| Example 2j | 240 | 346 | 44% |
| Example 2k | 744 | 1056 | 42% |
| Example 2l | 470 | 624 | 33% |

TABLE 4
Exposure to Ammonia-resistance measurements after leaving overnight

| | Resistance/kOhm | | |
|---|---|---|---|
| Ammonia | Before | After overnight | Difference |
| Example 2m | 890 | 1110 | 25% |
| Example 2n | 251 | 295 | 18% |
| Example 2o | 9412 | 942 | 18% |
| Example 2p | 570 | 570 | 17% |

As is apparent from the tables, the resistance of the printed conductive elements increases with exposure to acetic acid and ammonia fumes. The resistance increases with increased duration of exposure. Consequently, the printed compositions are able to act as electronic sensors to these environmental fumes and can be readily incorporated by those skilled in the art into practical circuits and devices for sensing environmental gases and vapours. Similar patterns of response are seen with other environmental gases.

1. An electrophotographic ink composition comprising:
carbon nanotubes;
a resin; and
a dispersant comprising at least one polysiloxane;
wherein the dispersant is present in an amount from about 0.01 wt. % to about 30 wt. % based on the combined weight of carbon nanotubes and resin.

2. A composition according to claim 1 wherein the polysiloxane is a trisiloxane.

3. A composition according to claim 1 wherein the polysiloxane has at least one polyether group.

4. A composition according to claim 3 wherein the at least one polyether group is a polymethyl ether group, a polyethyl ether group, a polypropyl ether group or a polyether block copolymer comprising polyether groups selected from methyl ether, ethyl ether and propyl ether.

5. A composition according to claim 1 wherein the polysiloxane is a polyalkylsiloxane.

6. A composition according to claim 5 wherein the alkyl groups of the polyalkylsiloxane are selected from methyl, ethyl, n-propyl and iso-propyl groups.

7. A composition according to claim 1 wherein the polysiloxane is a polyethylene oxide polysiloxane or a polypropylene oxide polysiloxane or a polysiloxane of formula I: 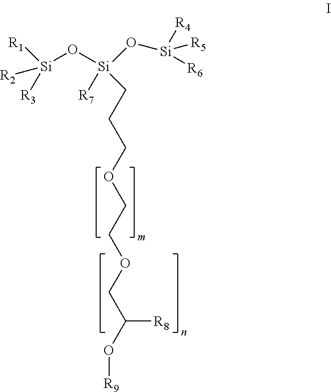
in which each of R₁ to R₉ are H, methyl or ethyl and may be the same or different;
and in which m and n each equal 0 to 20 and may be the same or different provided that m+n is 2 or greater.

8. A composition according to claim 7 wherein the polysiloxane is a polysiloxane of formula 1 and wherein R₁ to R₈ are each methyl and R₉ is H, methyl, ethyl or propyl.

9. A composition according to claim 8 wherein n=0 and m is 2 to 12, 4 to 10 or 6 to 8.

10. A composition according to claim 1 wherein the polysiloxane is a polyethylene oxide heptamethylsiloxane or polypropylene oxide heptamethylsiloxane or polypropylene oxide polyethylene oxide heptamethylsiloxane.

11. A composition according to claim 1 wherein the polysiloxane has a molecular weight of 300 to 900, 400 to 800, 500 to 700 or about 600.

12. A composition according to claim 1 wherein the carbon nanotubes are present in an amount of up to about 65 wt. % based on the weight of resin.

13. A composition according to claim 1, further comprising at least one of a colorant and a carrier liquid.

14. A method of producing a liquid electrophotographic ink composition, the method comprising combining:
a resin;
carbon nanotubes; and
a dispersant present in an amount from about 0.01 wt. % to about 30 wt. % based on the combined weight of carbon nanotubes and resin, wherein the dispersant is a polysiloxane.

15. An environmental sensor comprising a printed conductive trace formed by printing an electrophotographic ink composition, wherein the electrophotographic ink composition comprises carbon nanotubes, a resin and a dispersant, wherein the dispersant is an organic hydrocarbon based dispersant, a basic amine dispersant or a polysiloxane dispersant.
